(19) United States
(12) Patent Application Publication
(10) Pub. No.: US 2017/0160445 A1
(43) Pub. Date: Jun. 8, 2017

(54) OPTICAL FILM AND MANUFACTURING METHOD THEREOF

(71) Applicants: Chunghwa Picture Tubes, Ltd., Taoyuan City (TW); Tatung University, Taipei (TW)

(72) Inventors: Chuang-Hung Chiu, Hsinchu County (TW); Chao-Heng Chien, Taipei City (TW); Yueh-Hao Chen, New Taipei City (TW); Wei-Cheng Chien, Taipei City (TW)

(21) Appl. No.: 15/170,921

(22) Filed: Jun. 1, 2016

(30) Foreign Application Priority Data
Dec. 7, 2015 (CN) 201510886769.2

(51) Int. Cl. G02B 5/02; G02B 1/111; G02B 1/04

(52) U.S. Cl. CPC G02B 5/0242; G02B 1/04; G02B 1/111; G02B 5/0278

(57) ABSTRACT

An optical film includes a first substrate and a second substrate. A plurality of first particles are doped and dispersed in the first substrate, and a plurality of second particles are doped and dispersed in the second substrate. The first substrate has a top surface and a bottom surface, wherein the top surface is a flat surface and the bottom surface is a rough surface. The second substrate is attached to the bottom surface of the first substrate and the second substrate has flat surfaces.

### CROSS REFERENCE TO RELATED APPLICATIONS

The present application is based on and claims the foreign priority of China Patent Application No. 201510886769.2 filed on Dec. 7, 2015, the contents of which are hereby incorporated by reference in their entirety.

### BACKGROUND OF THE INVENTION

1. Field of the Invention

The present invention relates to an optical film and a manufacturing method thereof, and more particularly, to an optical film and its manufacturing method for enhancing the brightness of a display panel.

2. Description of the Prior Art

A display panel has smooth surface, and therefore the light displayed by the display panel and the light incident into the display panel would both greatly loss due to light reflection. In general, in order to improve this phenomenon and enhance the display effect of the display panel, an optical film is commonly provided to cover the display panel by the manufacturer so as to reduce the reflection and refraction of light. However, the transparency of the optical film would also affect the display effect of the display panel.

### SUMMARY OF THE INVENTION

It is therefore one of the objectives of the present invention is to provide an optical film and a manufacturing method thereof so as to enhance the brightness of the display panel, elevate the light guide effect and improve the transparency of conventional optical film.

To achieve the above objective, one of the embodiments of the present invention provides an optical film that includes a first substrate, a plurality of first particles, a second substrate and a plurality of second particles. The first substrate has a top surface and a bottom surface, wherein the top surface is a flat surface and the bottom surface is a rough surface. The first particles are dispersed and doped within the first substrate. The second substrate is attached to the bottom surface of the first substrate, and the second substrate has flat surfaces. The second particles are dispersed and doped within the second doped substrate.

To achieve the above objective, one of the embodiments of the present invention provides a method of manufacturing an optical film including the following steps. First, a first solution is provided. Next, a plurality of first particles is doped to the first solution and is uniformly dispersed in the first solution, wherein the first solution is in a colloidal state. Then, the first solution doped with the first particles doped is placed on a first carrier. The first solution is solidified to become a first substrate, wherein a surface of the first substrate has a roughened structure, and the surface having the roughened structure is defined as a bottom surface of the first substrate. Subsequently, the first substrate is separated from the first carrier. The method of manufacturing the optical film of the present invention further includes the following steps. A second solution is provided. Next, a plurality of second particles is doped to the second solution and is uniformly dispersed in the second solution, wherein the second solution is in a colloidal state. Then, the second solution doped with the second particles is placed on a second carrier, and the second solution is gradually solidified to become a second substrate, wherein the second carrier has a planar surface and the second substrate has flat surfaces. Before the second substrate completely solidifies, the first substrate is disposed on the second substrate to enable the bottom surface of the first substrate to be in contact with the second substrate. Subsequently, the second substrate completely solidifies to constitute an optical film with the first substrate. Then, the optical film is separated from the second carrier.

The first substrate and the second substrate of the optical film of the present invention are respectively doped with the first particles and the second particles, and light scattering and light refraction may occur due to the first particles and the second particles in the first substrate and the second substrate respectively. When the ambient light enters the optical film, the ambient light may be able to preserve in the optical film due to the scattering and refraction functionality of the first particles and the second particles. In addition, the roughened structure of the bottom surface of the first substrate may perform the converging effect to effectively collect the ambient light in cooperation with the above-mentioned structure of the present invention, such that the amount of the ambient light entering the second substrate increases. Moreover, when the light from the bottom surface of the second substrate entering the first substrate passes through the roughened structure, the light may be further scattered. As such, the light emitted from the top surface of the first substrate is more homogenized and the brightness of the display panel is increased. Furthermore, the optical film has a higher transparency due to the material and the amount of the first particles and the second particles in cooperation with the first substrate and the second substrate of the optical film of the present invention, and thereby the image performance of the display panel is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method of manufacturing an optical film according to the present invention.

FIG. 2 is a schematic diagram of providing a material of a first substrate according to the method of manufacturing the optical film of the present invention.

FIG. 3 is a schematic diagram of manufacturing the first substrate of the optical film according to the present invention.

FIG. 4 is an enlarged schematic diagram of the first substrate shown in FIG. 3 according to the present invention.

FIG. 5 is a schematic diagram of providing a material of a second substrate according to the method of manufacturing the optical film of the present invention.

FIG. 6 is a schematic diagram of manufacturing the second substrate of the optical film according to the present invention.

FIG. 7 is a schematic diagram of combining the first substrate and the second substrate according to the method of manufacturing the optical film of the present invention.

FIG. 8 is a cross-sectional view of the optical film according to the present invention.

FIG. 9 is a schematic diagram of optical paths of the optical film of the present invention when being applied on a display panel.

FIG. 10 is a schematic diagram of manufacturing a first substrate of the optical film according to a variant embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

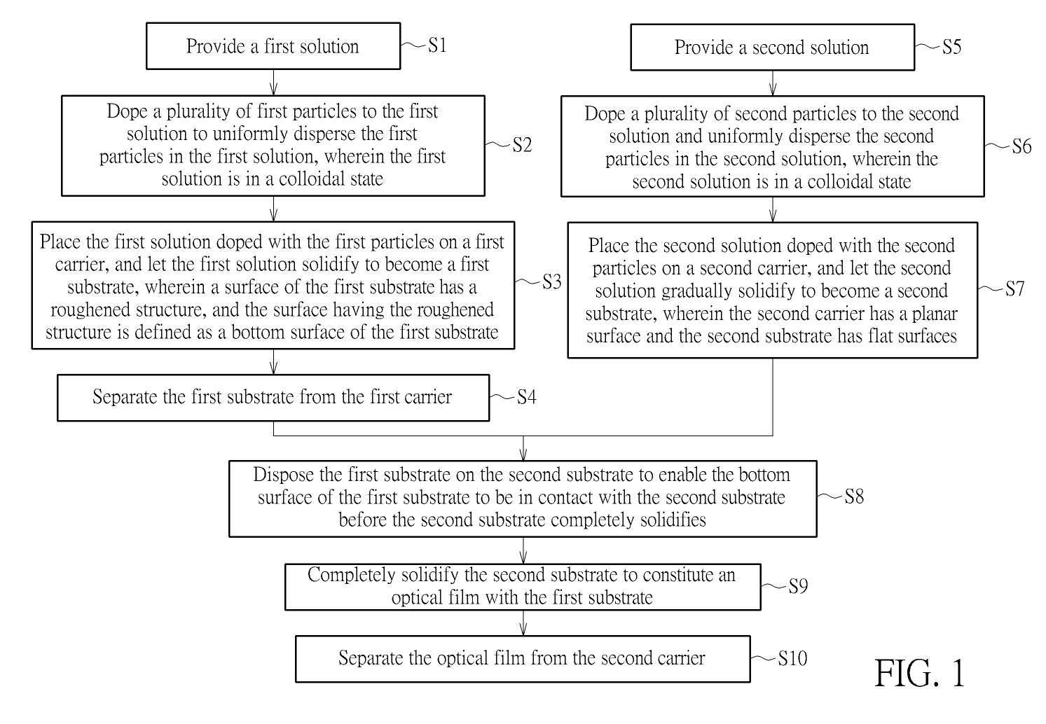

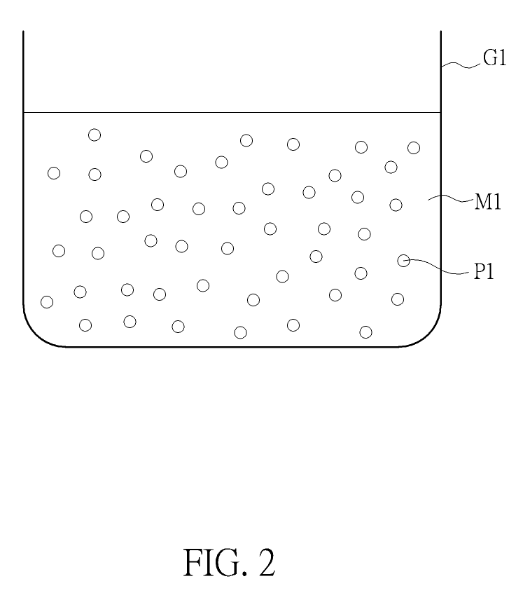

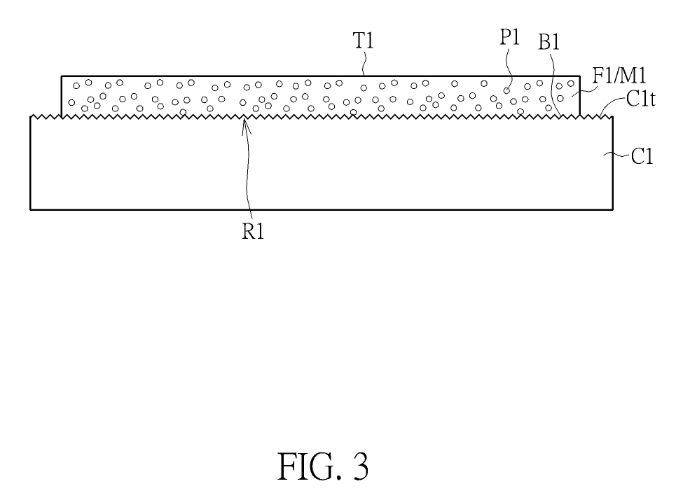

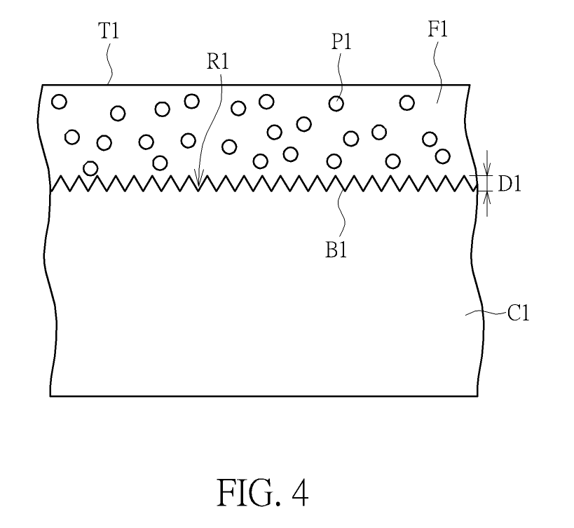

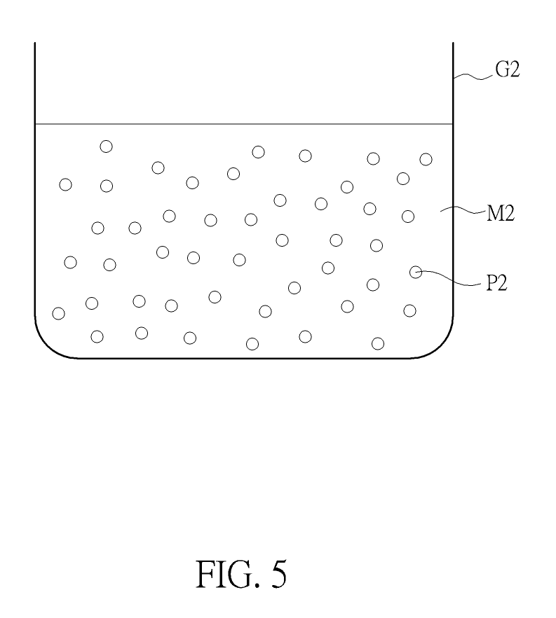

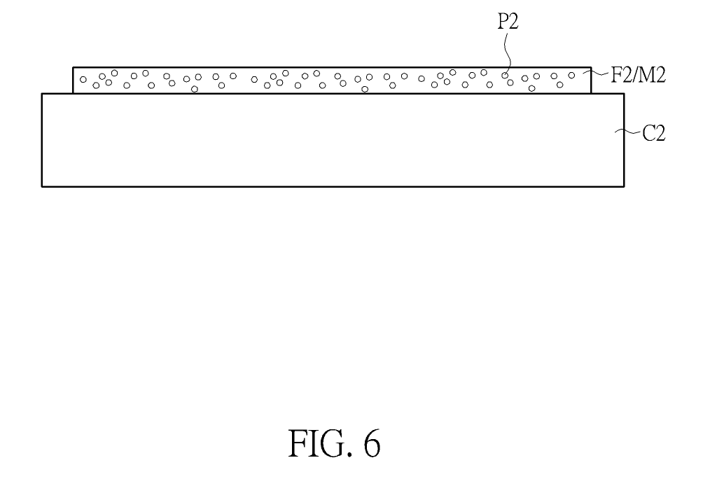

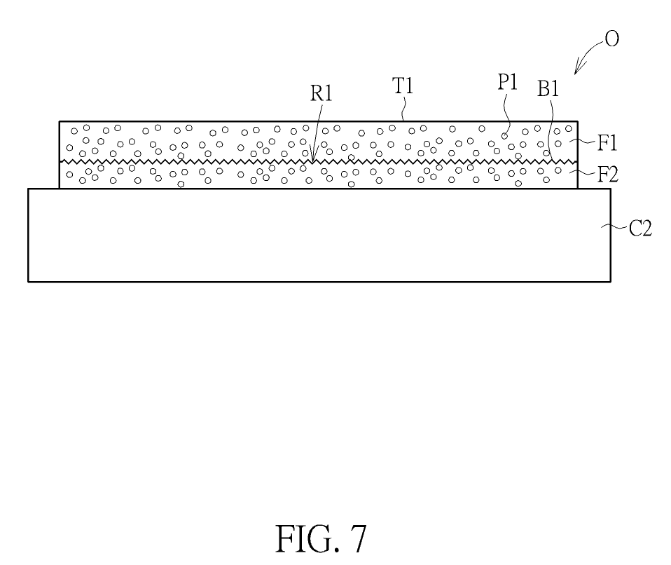

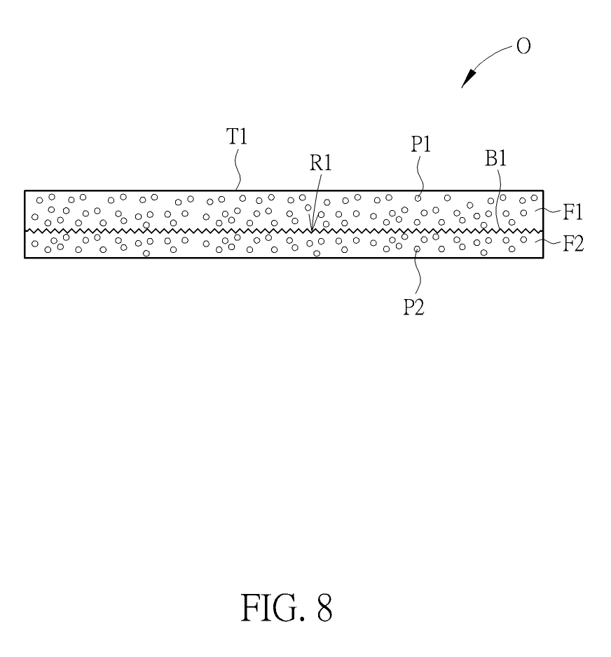

The present invention provides an optical film, which may be applied to the surface of a display panel, e.g., the surface of the liquid crystal display panel, thereby increasing the brightness of the display panel surface. The optical film of the present invention mainly includes a first substrate and a second substrate, and the methods of manufacturing the first substrate and the second substrate as well as the structure of the optical film of the present invention formed by combining the first substrate and the second substrate will be detailed as follows. Please refer to FIG. 1 to FIG. 8. FIG. 1 is a flowchart of a method of manufacturing an optical film according to the present invention. FIG. 2 to FIG. 7 are schematic diagrams showing the fabrication processes of the method of manufacturing the optical film according to the present invention, wherein FIG. 2 illustrates the process of providing a material of a first substrate of the optical film, FIG. 3 illustrates the process of fabricating the first substrate of the optical film, FIG. 4 is an enlarged schematic diagram of the first substrate shown in FIG. 3, FIG. 5 illustrates the process of providing a material of a second substrate of the optical film, FIG. 6 illustrates the process of fabricating the second substrate of the optical film, FIG. 7 illustrates the process of combining the first substrate and the second substrate of the optical film of the present invention, and FIG. 8 is a cross-sectional view of the optical film according to the present invention.

First, as shown in FIG. 1 and FIG. 2, according to the method of manufacturing the optical film of the present invention, the method of manufacturing the first substrate includes performing Step S1 to provide a first solution M1. The first solution M1 could be poured into the first container G1 for example, wherein the first solution M1 includes organosilicon compound, e.g., polydimethylsiloxane (PDMS). For instance, the first solution M1 may be a solution of PDMS and a curing agent in a specific proportion, wherein the ratio of PDMS and the curing agent may be 10:1, but not limited thereto.

Next, Step S2 is performed. A plurality of first particles P1 are doped to the first solution M1 and the first particles P1 are uniformly dispersed in the first solution M1, wherein the first solution M1 is in a colloidal state. The size of the first particles P1 ranges from about 0.01 micrometers (pm) to about 7 micrometers, and the amount of the first particles P1 dispersed and doped within the first solution M1 ranges preferably from about 0.1 wt % to about 1 wt % based on the total weight of the solution, but not limited thereto. Moreover, the first particles P1 may be selected from the group consisting of: Group 2 oxides, Group 4 oxides, Group 13 oxides, and Group 14 oxides. The first particles P1 may include two to four kinds of oxides and the two to four kinds of oxides are preferably different group element oxides from each other among the aforementioned group element oxides. For example, if the first particles P1 include two oxides, the two oxides are two kinds of oxides selected from two different groups of the aforementioned group element oxides; if the first particles P1 include three oxides, the three oxides are three kinds of oxides selected from three different groups of the aforementioned group element oxides; and if the first particles P1 include four oxides, the four oxides are four kinds of oxides respectively selected from four different groups of the aforementioned group element oxides. For instance, the first particles P1 of the present invention may include calcium oxide, aluminum oxide, silicon oxide and zirconium oxide at the same time, but the present invention is not limited thereto. In another example, the first particles P1 may only include two to three kinds of the oxides among calcium oxide, aluminum oxide, silicon oxide and zirconium oxide. Furthermore, the refractive index of the first particles P1 is preferably in a range from about 1.4 to about 1.9 and from about 2.3 to about 2.5. It is worth mentioning that, after performing Step S2, the first solution M1 doped with the first particles P1 may be placed in a vacuum environment so as to discharge bubble from the first solution M1. For instance, the first solution M1 may be placed in vacuum for 30 minutes.

Next, as shown in FIG. 1 and FIG. 3, Step S3 is performed to place the first solution M1 doped with the first particles P1 on a first carrier C1, and let the first solution M1 be solidified to become a first substrate F1, wherein a surface of the first substrate F1 has a roughened structure R1, and the surface having the roughened structure R1 is defined as a bottom surface B1 of the first substrate F1. For example, in the present embodiment, the surface of the first carrier C1 has a microstructure C1t, so that when the first solution M1 is placed on the first carrier C1 and is solidified to become the first substrate F1, the bottom surface B1 would have the roughened structure R1. In addition, the first substrate F1 after solidifies has a top surface T1 opposite to the rough bottom surface B1, wherein the top surface T1 is a flat surface, but the present invention is not limited thereto. It is worth mentioning that, the step of placing the first solution M1 on the first carrier C1 may include pouring the first solution M1 onto the first carrier C1 and performing a spin coating process to let the first solution M1 on the first carrier C1 have a uniform flat surface, for instance. Noting that the step of placing the first solution M1 on the first carrier C1 is not limited to the above method, any other method that makes the first solution M1 on the first carrier C1 have a uniform flat surface may be applied to the present invention.

Please refer to FIG. 4, wherein FIG. 4 is an enlarged schematic diagram of the first substrate F1 shown in FIG. 3. According to the present invention, the height difference D1 of the roughened structure R1 of the bottom surface B1 of the first substrate F1 is defined as the distance between the top end and the bottom end of the roughened structure R1. Then, the height difference D1 of the roughened structure R1 preferably ranges from about 5 micrometers to about 10 micrometers, but not limited thereto. Further, the bottom surface B1 of the first substrate F1 may be a textured surface such that the bottom surface B1 is a rough and uneven surface. It is noteworthy that, the roughened structure R1 of the bottom surface B1 may have any shape of patterns. For example, the patterns of the roughened structure R1 may be circular, square-shaped, pyramid-shaped or prism-shaped, but the present invention is not limited to. In addition, the patterns of the roughened structure R1 maybe regularly or randomly arranged on the bottom surface B1.

It is noteworthy that the first solution M1 is directly solidified to become the first substrate F1 in the present embodiment, but the present invention is not limited thereto. In another embodiment, in order to reduce the solidification time of the first solution M1 to become the first substrate F1, the first solution M1 may be baked, such that the solidification of the first solution M1 can be accelerated. In one embodiment of the present invention, the first solution M1 may be baked at a controlled temperature above the room temperature, such as at the temperature in a range from about 25° C. to about 110° C., preferably at the temperature in a range from about 75° C. to about 85° C., but not limited thereto.

Next, Step S4 is performed according to FIG. 1. The first substrate F1 is separated from the first carrier C1 to complete the manufacturing process of the first substrate F1. The refractive index of the first substrate F1 manufactured by the aforementioned method ranges from about 1.4 to about 1.6. In addition, as described above, the amount of the first particles P1 dispersed and doped within the first substrate F1 ranges from about 0.1 wt % to about 1 wt %, so that the transparency of the first substrate F1 is barely affected. Accordingly, the transparency of the first substrate F1 is greater than 95%. Further, the thickness of the first substrate F1 preferably ranges from about 100 micrometers to about 500 micrometers, such that the first substrate F1 is easier to be separated from the first carrier C1, but not limited thereto.

In another aspect, the method of manufacturing the second substrate will be detailed as follows. Please refer to FIG. 1 and FIG. 5. First, Step S5 is performed to provide a second solution M2. For example, the second solution M2 is provided by being poured into the second container G2, but not limited thereto. The second solution M2 includes organosilicon compound e.g., PDMS. In the present embodiment, the material of the second solution M2 may be the same as the material of the first solution M1, but not limited thereto.

In other embodiments, for example, the material of the second solution M2 maybe different from the material of the first solution M1. Next, referring to FIG. 5 and FIG. 1 again, Step S6 is performed. A plurality of second particles P2 are doped to the second solution M2, and the second particles P2 are uniformly dispersed in the second solution M2, wherein the second solution M2 is in a colloidal state. The size of the second particles P2 ranges from about 0.01 micrometers (μm) to about 7 micrometers, and the amount of the second particles P2 dispersed and doped within the second solution M2 ranges from about 0.1 wt % to about 1 wt %. Moreover, the second particles P2 are selected from the group consisting of: Group 2 oxides, Group 4 oxides, Group 13 oxides, and Group 14 oxides. The second particles P2 may include two to four kinds of oxides and the two to four kinds of oxides are preferably belong to different group element oxides of the aforementioned group element oxides respectively. The composition of the second particles P2 may be the same as the composition of the first particles P1, and will not be redundantly described. Furthermore, the refractive index of the second particles P2 is preferably in a range from about 1.4 to about 1.9 and from about 2.3 to about 2.5 so as to provide suitable optical properties for the optical film of the present invention. For example, the second particles P2 may only include two to four kinds of the oxides among calcium oxide, aluminum oxide, silicon oxide and zirconium oxide, and may be uniformly dispersed in the second solution M2 according to a specific ratio, but the present invention is not limited thereto. It is worth mentioning that, the materials of the second particles P2 maybe chosen to be the same as or different from the materials of the first particles P1. In addition, after performing Step S6, the second solution M2 doped with the second particles P2 may be placed in a vacuum environment so as to discharge bubbles from the second solution M2.

Next, please refer to FIG. 1 and FIG. 6. Step S7 is performed to place the second solution M2 doped with the second particles P2 onto a second carrier C2 and let the second solution M2 be gradually solidified to become a second substrate F2. It is worth mentioning that the step of placing the second solution M2 on the second carrier C2 may include pouring the second solution M2 on the second carrier C2 and performing a spin coating process to let the second solution M2 on the second carrier C2 have a uniform flat surface. Noting that the step of placing the second solution M2 on the second carrier C2 is not limited to the above method, any other method that makes the second solution M2 on the second carrier C2 have a uniform flat surface may be applied to the present invention. According to the present invention, a thickness of the second substrate F2 ranges from about 100 micrometers to about 300 micrometers, but not limited thereto. Further, the second carrier C2 has a planar surface, such that the second solution M2 coated thereon also has flat surfaces. The refractive index of the second substrate F2 ranges from about 1.4 to about 1.6. In addition, since the amount of the second particles P2 dispersed and doped within the second substrate F2 ranges from about 0.1 wt % to about 1 wt %, the transparency of the second substrate F2 is barely affected, and the transparency of the second substrate F2 is greater than 95%. It is noteworthy that the inaccuracy of the described weight percentage of the second particles P2 in the second substrate F2 and the described weight percentage of the first particles P1 in first substrate F1 are less than about 0.5 wt %.

Then, refer to FIG. 7 and perform Step S8 shown in FIG. 1. Before the second substrate F2 completely solidifies, the first substrate F1 is disposed on the second substrate F2 to enable the bottom surface B1 of the first substrate F1 to be in contact with the second substrate F2. In other words, the bottom surface B1 of the first substrate F1 having the roughened structure R1 is directly attached to the top surface of the second substrate F2. Since the second substrate F2 is still sticky before completely solidifying, the bottom surface B1 of the first substrate F1 is stuck and fixed on the top surface of the second substrate F2, and no other layer is disposed between the first substrate F1 and the second substrate F2 in the present embodiment. However, the resent invention is not limited to the above description. The first substrate F1 may be attached to the second substrate F2 via an adhesive layer, e.g., optical clear adhesive.

Subsequently, Step S9 is performed to completely solidify the second substrate F2 to constitute an optical film O with the first substrate F1. In the present embodiment, after the first substrate F1 is disposed on the top surface of the second substrate F2, the second substrate F2 is directly solidified to constitute the optical film O with the first substrate F1. The present invention is not limited to the above description. In another embodiment, in order to reduce the solidification time of the second substrate F2, the second substrate F2 may be baked after the first substrate F1 is disposed on the top surface of the second substrate F2, such that the solidification of the second substrate F2 is accelerated. In one embodiment of the present invention, the temperature may be controlled to be above the room temperature when baking the second substrate F2. For instance, the baking temperature maybe in a range from about 25° C. to about 110° C. Preferably, the temperature may be in a range from about 75° C. to about 85° C., but the present invention is not limited thereto. It is worth mentioning that the physical properties and chemical properties of the first substrate F1 will not change although the first substrate F1 may be baked together with the second substrate F2.

Finally, please refer to FIG. 8. Step S10 shown in FIG. 1 is performed to separate the optical film O from the second carrier C2. As shown in FIG. 8, the optical film O of the present invention includes the first substrate F1, the plurality of first particles P1, the second substrate F2 and the plurality of second particles P2. The first particles P1 are dispersed and doped within the first substrate F1, and the second particles P2 are dispersed and doped within the second substrate F2. The first substrate F1 has the top surface T1 and the bottom surface B1, wherein the top surface T1 is a flat surface, and the bottom surface B1 is a rough surface. In addition, the second substrate F2 is attached to the bottom surface B1 of the first substrate F1, and the second substrate F2 has flat surfaces.

In another aspect, the method of manufacturing the optical film O of the present invention may be summarized as follows, which includes the following steps, as shown in FIG. 1.

Step S1: Provide a first solution M1.

Step S2: Dope a plurality of first particles P1 to the first solution M1 and uniformly disperse the first particles P1 in the first solution M1, wherein the first solution M1 is in a colloidal state.

Step S3: Place the first solution M1 doped and dispersed with the first particles P1 on a first carrier C1, and let the first solution M1 solidify to become a first substrate F1, wherein a surface of the first substrate F1 has a roughened structure R1, and the surface having the roughened structure R1 is defined as a bottom surface B1 of the first substrate F1.

Step S4: Separate the first substrate F1 from the first carrier C1.

Step S5: Provide a second solution M2.

Step S6: Dope a plurality of second particles P2 in the second solution M2 and uniformly disperse the second particles in the second solution M2, wherein the second solution M2 is in a colloidal state.

Step S7: Place the second solution M2 doped and dispersed with the second particles P2 on a second carrier C2, and let the second solution M2 gradually solidify to become a second substrate F2, wherein the second carrier C2 has a planar surface, and the second substrate F2 has flat surfaces.

Step S8: Before the second substrate F2 completely solidifies, dispose the first substrate F1 on the second substrate F2 to enable the bottom surface B1 of the first substrate F1 to be in contact with the second substrate F2.

Step S9: Completely solidify the second substrate F2 to constitute an optical film O with the first substrate F1.

Step S10: Separate the optical film O from the second carrier C2.

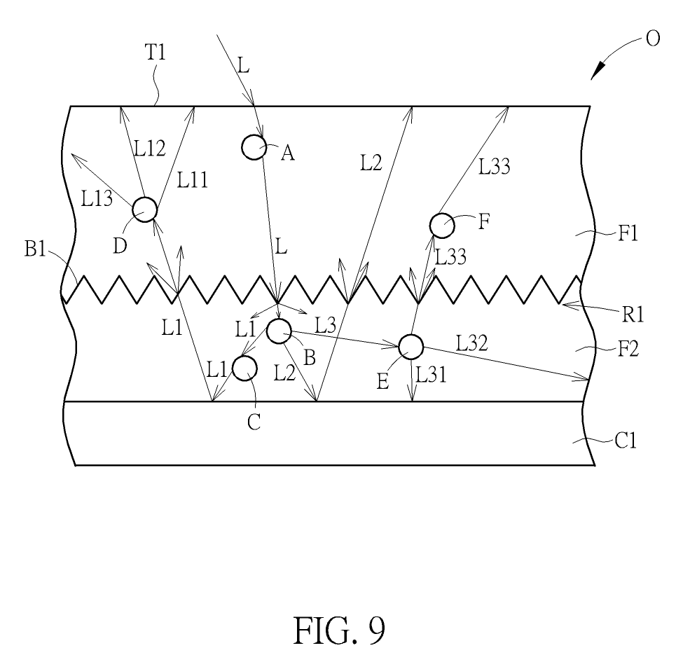

Please refer to FIG. 9. FIG. 9 is a schematic diagram of optical paths of the optical film of the present invention when being applied on a display panel. The optical film O of the present invention manufactured by the aforementioned method is disposed on the display surface of the display panel H. The second substrate F2 of the optical film O is disposed between the display panel Hand the first substrate F1. In other words, the second substrate F2 is disposed adjacent to the display panel H and the first substrate F1 is disposed away from the display panel H. The display panel H may be a flexible display panel or a rigid display panel, such as a liquid crystal display panel, an organic light emitting diode display panel or an inorganic light emitting diode display panel, but not limited thereto.

To clarify the present invention, the schematic diagram of FIG. 9 only illustrates part of the optical paths, but those skilled in the art should be aware that the optical paths in FIG. 9 are only examples, which describes the influence of the first particles P1 and the second particles P2 having the scattering and/or refraction properties on the direction of the light. The present invention is not limited to the optical paths illustrated in FIG. 9. The particles A, D, F represent the first particles P1, and the particles B, C, E represent the second particles P2. Taking the light L for example, when the light L enters the optical film O, refraction may occur, so that the light L will be slightly deviate from the original progressing direction. Then, as the light L contacts the particle A, the light L is refracted by the particles A while the particle A have refractive property, thereby changing its progressing direction. Since the bottom surface B1 of the first substrate F1 has the roughened structure R1, the bottom surface B1 has a better converging effect and scattering effect. Thus, as the light propagates to the contact surface of the first substrate F1 and the second substrate F2, the path of the light L will be divided into multiple optical paths after passing through the roughened structure R1 such that the light in the second substrate F2 is more homogenized. Then, when the light L contacts the particle B having scattering property, the light L may be scattered and be divided into the light L1, L2 and L3 . The light L1 contacts the particle C having refractive property will be further refracted to propagate to the contact surface of the second substrate F2 and the display panel H, and then be reflected upward. Similarly, since the roughened structure R1 has a better converging effect and scattering effect, the light L1 contacting the bottom surface B1 of the first substrate F1 having the roughened structure R1 will be divided into multiple optical paths after passing through the roughened structure R1, such that the light entering the first substrate F1 is more homogenized. When the light L1 contacts the particle D having scattering property, the light L1 will be scattered and be divided into the light L11, L12 and L13. In another aspect, the light L2 may be reflected back to the second substrate F2 after propagating to the contact surface of the second substrate F2 and the display panel H, and may be further divided into multiple light paths after passing through the roughened structure R1 before propagating back to the air. As for the light L3, when the light L3 contacts the particle E having scattering property, the light L3 will be scattered and be divided into the light L31, light L32 and light L33. The light L33 passes through the bottom surface B1 of the first substrate F1 having the roughened structure R1 and contacts the particle F. Similarly, if the particle F has refractive property, the light L33 is refracted back to the air.

From the foregoing, the first substrate F1 and the second substrate F2 of the optical film O of the present invention are respectively doped with the first particles P1 and the second particles P2, which respectively include two or more kinds of different group element oxides. The first particles P1 and the second particles P2 in the first substrate F1 and the second substrate F2 have scattering and refractive properties respectively. When the ambient light enters the optical film O, it may be mostly preserved in the optical film O due to the scattering and refraction effects of the first particles P1 and the second particles P2. In addition, the roughened structure R1 of the bottom surface B1 of the first substrate F1 may provide the converging effect, and the ambient light may be effectively collected, such that the amount of the ambient light entering the second substrate F2 increases. The light reflected from the bottom surface of the second substrate F2 to enter the first substrate F1 via the roughened structure R1 maybe further scattered, and the ambient light propagating into the second substrate F2 may be also scattered by the roughened structure R1. As such, the light emitted from the top surface of the first substrate F1 is more homogenized and the brightness of the display panel H is increased. Furthermore, the optical film O has a higher transparency due to the specific materials and amounts of the first particles P1 and the second particles P2 in the first substrate F1 and the second substrate F2 of the optical film O of the present invention respectively, and thereby the image performance of the display panel H is improved.

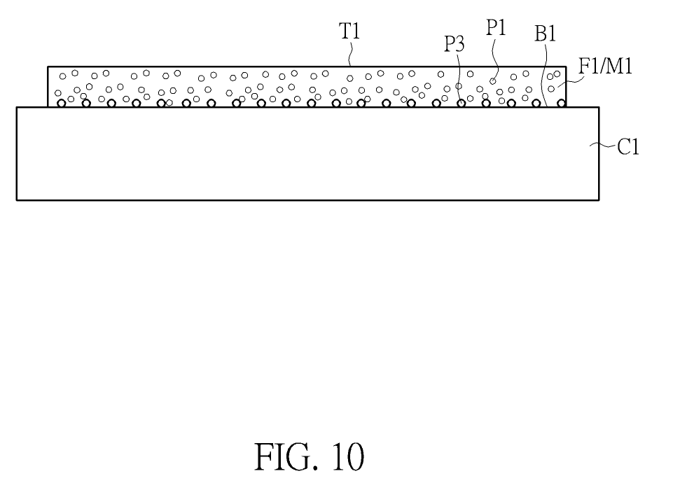

The optical film and the manufacturing method thereof are not limited by the aforementioned embodiment, and may have other different preferred embodiments. To simplify the description, the identical components in each of the following embodiments are marked with identical symbols. For making it easier to compare the differences between the embodiments, the following description will detail the dissimilarities among different embodiments and the identical features will not be redundantly described. Please refer to FIG. 10. FIG. 10 is a schematic diagram of manufacturing a first substrate of the optical film according to a variant embodiment of the present invention. In the variant embodiment, the first carrier C1 may not have the microstructure. The method for manufacturing the roughened structure R1 of the bottom surface B1 of the first substrate F1 includes the following steps. First, the first solution M1 doped and dispersed with the first particles P1 is placed on a first carrier C1. Then, before the first solution M1 is completely solidified to become a film-like first substrate F1, a plurality of third particles P3 are sprayed on the surface of the first substrate F1 so as to form the roughened structure on the surface of the first substrate F1. As shown in FIG. 10, the sprayed third particle P3 is disposed on the upper surface of the first substrate F1, wherein the upper surface is considered the bottom surface B1 of the first substrate F1 after it completely solidifies, and the lower surface at this time is considered the top surface T1 of the first substrate F1. It should be noted that the size of the third particles P3 preferably ranges from about 1 micrometer to about 20 micrometers, and the amount of the third particles P3 disposed on the bottom surface B1 of the first substrate F1 ranges from about 0.0001 g/cm² to about 0.001 g/cm². The refractive index of the third particles P3 ranges from about 1.4 to about 1.6. For example, a material of the third particles includes silicon oxide, but the present invention is not limit thereto. Similar to FIG. 7, after the first substrate F1 completely solidifies, the first substrate F1 is separated from the first carrier C1 and is turned upside down to be attached to the surface of the second substrate F2 which does not completely solidify. After the second substrate F2 completely solidifies, the second substrate F2 is separated from the second carrier C2 to complete the manufacture of the optical film O of the present invention.

Another embodiment of the method of manufacturing the optical film of the present invention is described as follows. During the manufacturing of the first substrate F1, the first carrier C1 similar to FIG. 10 is provided so as to let the first substrate F1 have a flat bottom surface. In another aspect, during the manufacturing of the second substrate F2, the third particles P3 are sprayed on the top surface of the second substrate F2 before it completely solidifies. Subsequently, the completely solidified first substrate F1 is attached to the top surface of the second substrate F2, so that the third particles P3 is disposed between the first substrate F1 and the second substrate F2, and the third particles P3 protruded from the second substrate F2 would let the bottom surface B1 of the first substrate F1 have a similar effect as the roughened structure.

In summary, the first substrate and the second substrate of the optical film of the present invention are respectively doped with the first particles and the second particles, and light scattering and light refraction may occur due to the first particles and the second particles in the first substrate and the second substrate respectively. When the ambient light enters the optical film, the ambient light may be mostly preserved in the optical film due to the scattering and refraction effects of the first particles and the second particles. In addition, the roughened structure of the bottom surface of the first substrate may exhibit the converging effect and the ambient light may be effectively collected, such that the amount of the ambient light entering the second substrate increases. When the light from the bottom surface of the second substrate enters the first substrate via the roughened structure, the light may further be scattered. As such, the light emitted from the top surface of the first substrate is more homogenized and the brightness of the display panel is increased. Furthermore, the optical film has a higher transparency due to the specific materials and amounts of the first particles and the second particles respectively in the first substrate and the second substrate of the optical film of the present invention. Accordingly, the image performance of the display panel is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical film, comprising:
a first substrate, wherein the first substrate has a top surface and a bottom surface, the top surface is a flat surface, and the bottom surface is a rough surface;
a plurality of first particles dispersed and doped within the first substrate;
a second substrate attached to the bottom surface of the first substrate, wherein the second substrate has flat surfaces; and
a plurality of second particles dispersed and doped within the second doped substrate.

2. The optical film according to claim 1, wherein a material of the first substrate and a material of the second substrate respectively comprise polydimethylsiloxane.

3. The optical film according to claim 1, wherein the first substrate and the second substrate respectively comprise organosilicon compound, a refractive index of the first substrate and a refractive index of the second substrate respectively range from about 1.4 to about 1.6, and a transparency of the first substrate and a transparency of the second substrate are respectively greater than 95%.

4. The optical film according to claim 1, wherein the bottom surface of the first substrate has a roughened structure.

5. The optical film according to claim 4, wherein a height difference of the roughened structure ranges from about 5 micrometers to about 10 micrometers.

6. The optical film according to claim 1, further comprising a plurality of third particles disposed between the first substrate and the second substrate.

7. The optical film according to claim 6, wherein a size of the third particles ranges from about 1 micrometer to about 20 micrometers.

8. The optical film according to claim 6, wherein an amount of the third particles disposed on the bottom surface of the first substrate ranges from about 0.0001 g/cm² to about 0.001 g/cm², a refractive index of the third particles ranges from about 1.4 to about 1.6, and a material of the third particles comprises silicon oxide.

9. The optical film according to claim 1, wherein a size of the first particles and a size of the second particles respectively ranges from about 0.01 micrometers to about 7 micrometers.

10. The optical film according to claim 1, wherein the first particles and the second particles are independently selected from the group consisting of: Group 2 oxides, Group 4 oxides, Group 13 oxides, and Group 14 oxides.

11. The optical film according to claim 10, wherein the first particles and the second particles respectively independently comprise two to four kinds of oxides and the two to four kinds of oxides are different group element oxides.

12. The optical film according to claim 1, wherein a refractive index of the first particles is in a range from about 1.4 to about 1.9 and from about 2.3 to about 2.5, and a refractive index of the second particles is in a range from about 1.4 to about 1.9 and from about 2.3 to about 2.5.

13. The optical film according to claim 1, wherein an amount of the first particles in the first substrate ranges from about 0.1 wt % to about 1 wt %, and an amount of the second particles in the second substrate ranges from about 0.1 wt % to about 1 wt %.

14. A method of manufacturing an optical film, comprising:
providing a first solution;
doping a plurality of first particles to the first solution and uniformly dispersing the first particles in the first solution, wherein the first solution is in a colloidal state;
placing the first solution doped with the first particles on a first carrier, and letting the first solution solidify to become a first substrate, wherein a surface of the first substrate has a roughened structure, and the surface having the roughened structure is defined as a bottom surface of the first substrate;
separating the first substrate from the first carrier;
providing a second solution;
doping a plurality of second particles to the second solution and uniformly dispersing the second particles in the second solution, wherein the second solution is in a colloidal state;
placing the second solution doped with the second particles on a second carrier, and letting the second solution gradually solidify to become a second substrate, wherein the second carrier has a planar surface and the second substrate has flat surfaces;
before the second substrate completely solidifies, disposing the first substrate on the second substrate to enable the bottom surface of the first substrate to be in contact with the second substrate;
completely solidifying the second substrate to constitute an optical film with the first substrate; and
separating the optical film from the second carrier.

15. The method of manufacturing the optical film according to claim 14, wherein a surface of the first carrier has a microstructure, such that the roughened structure is formed on the bottom surface of the first substrate, and the first substrate after solidifying has a top surface opposite to the bottom surface, the top surface being a flat surface.

16. The method of manufacturing the optical film according to claim 14, wherein a plurality of third particles are sprayed on the bottom surface of the first substrate before the first substrate completely solidifies, so as to form the roughened structure on the bottom surface of the first substrate.

17. The method of manufacturing the optical film according to claim 14, further comprising baking the first solution after placing the first solution on the first carrier, such that the first solution is solidified to become the first substrate.

18. The method of manufacturing the optical film according to claim 14, further comprising baking the second substrate after disposing the first substrate on the second substrate, such that the second substrate is completely solidified to constitute the optical film with the first substrate.

19. The method of manufacturing the optical film according to claim 14, wherein a thickness of the first substrate ranges from about 100 micrometers to about 500 micrometers and a thickness of the second substrate ranges from about 100 micrometers to about 300 micrometers.

20. The method of manufacturing the optical film according to claim 14, wherein the first particles and the second particles are independently selected from the group consisting of: Group 2 oxides, Group 4 oxides, Group 13 oxides, and Group 14 oxides, and the first particles and the second particles respectively independently comprise two to four kinds of oxides and the two to four kinds of oxides are respectively different group element oxides.
